(19) United States
(12) Patent Application Publication
(10) Pub. No.: US 2016/0313838 A1
(43) Pub. Date: Oct. 27, 2016

(54) Touch Screen Integrated Display Device

(71) Applicant: LG Display Co., Ltd., Seoul (KR)

(72) Inventors: HeonPil LEE, Daegu (KR); HyunSik CHOI, Gumi-si (KR); Sojeong JEONG, Daegu (KR)

(21) Appl. No.: 15/133,990

(22) Filed: Apr. 20, 2016

(30) Foreign Application Priority Data
Apr. 21, 2015 (KR) 10-2015-0055901
Jul. 30, 2015 (KR) 10-2015-0107781

(51) Int. Cl. G06F 3/041; G06F 3/044

(52) U.S. Cl. CPC G06F 3/0412; G06F 3/044

(57) ABSTRACT

A touch screen integrated display device includes a driving chip, a flexible printed circuit board, and a buffering member. The driving chip is disposed in a non-display area of a lower substrate. The flexible printed circuit board is connected to the lower substrate and covers at least a part of the driving chip. The buffering member disperses force applied to the lower substrate by the curved flexible printed circuit board. In the touch screen integrated display device, the tension which acts on the lower substrate by the curved touch printed circuit board is reduced or dispersed by the buffering member, so that minute deformation of the lower substrate may be reduced and the light leakage may be reduced.

### CROSS-REFERENCE TO RELATED APPLICATIONS

This application claims the priority of Korean Patent Application No. 10-2015-0055901, filed on Apr. 21, 2015, and Korean Patent Application No. 10-2015-0107781, filed on Jul. 30, 2015, the respective disclosures of which are incorporated herein by reference.

### BACKGROUND

1. Field

The present disclosure relates to a touch screen integrated display device. More particularly, the present disclosure relates to a touch screen integrated display device in which a light leakage phenomenon is reduced.

2. Description of the Related Art

A touch screen panel (TSP) is a device which senses a touch input of a user with respect to a display device. The touch screen panel may be an optical type, a resistive type, or an electrostatic capacitive type in accordance with a method of sensing a touch input of a user. Specifically, the electrostatic capacitive type may increase sharpness and touch accuracy of the display device. The electrostatic capacitive touch screen panel senses the changes of an electrostatic capacitance formed between touch electrodes to sense the touch input of the user.

Generally, a touch screen panel is manufactured as a separate panel to be attached onto a screen of the display device. In this case, an overall thickness of the display device is increased and visibility of the display device may be lowered due to the increased thickness.

In response to the above-described problems, an in-cell type touch screen integrated display device in which a touch screen panel is integrated into the display device is being developed.

Generally, a touch signal which is detected by a touch screen panel is transmitted to a touch sensing unit. The touch signal is transmitted to the touch sensing unit through a connector such as a touch printed circuit board in the form of a flexible printed circuit board (FPCB) type. The touch printed circuit board is implemented by the FPCB in the in-cell type touch screen integrated display device. The touch printed circuit board may be curved in a specific area and thus light leakage may be caused thereby. The light leakage by the touch printed circuit board will be described in more detail with reference to FIGS. 1 and 2.

FIG. 1 is a schematic perspective view illustrating a touch screen integrated display device 100 of the related art. FIG. 2 is a schematic cross-sectional view taken along the line II-II′ of FIG. 1 illustrating a light leakage phenomenon generated in the touch screen integrated display device 100. For convenience of explanation, in FIG. 1, a display element of the touch screen integrated display device 100 and a touch electrode of the touch screen are omitted and an upper substrate 170, which covers a lower substrate 110 is also omitted. Referring to FIGS. 1 and 2, the touch screen integrated display device 100 includes a lower substrate 110, a driving chip 130, a display printed circuit board 150, a touch printed circuit board 160, an upper substrate 170, and a black matrix 180.

The lower substrate 110 includes a display area and a non-display area. Display elements, a touch electrode of the touch screen, and the like are disposed in the display area of the lower substrate 110. The driving chip, pad units 141 and 142, and the like are disposed in the non-display area.

In the touch screen integrated display device 100, the touch electrode of the touch screen is disposed to be close to the display element. For example, when the touch screen integrated display device 100 is a liquid crystal display device, the touch electrode also functions as a common electrode of the display element. Continuing the example, the touch electrode and the common electrode of the display element are disposed on the same plane. In this case, a common voltage, which is applied to the common electrode, is supplied through the driving chip 130, which is connected to the display pad unit 141. A touch signal, which is generated through the touch electrode, is transmitted to the touch pad unit 142. Therefore, both the touch pad unit 142 and the display pad unit 141 are disposed on the same plane of the lower substrate 110. The display printed circuit board 150 is connected to the display pad unit 141, and the touch printed circuit board 160 is connected to the touch pad unit 142.

As illustrated in FIG. 1, the touch pad unit 142 is connected to the touch electrode, which mostly covers the display area of the lower substrate 110, in a one-to-one manner. The touch pad unit 142 includes a plurality of pads which are each connected to the touch electrode in a one-to-one relationship. The plurality of pads in the touch pad unit 142 is densely disposed on both ends of the driving chip 130 to maintain a thin bezel of the touch screen integrated display device 100. That is, the touch pad unit 142 is disposed to mostly cover an outer region of an area where the driving chip 130 is disposed. The touch printed circuit board 160 is bonded with the touch pad unit 142 and is in contact with the lower substrate 110 in a region where the touch pad unit 142 is disposed. As described above, the touch pad unit 142 is disposed to mostly cover both ends of the region where the driving chip 130 is disposed. Therefore, the touch printed circuit board 160 is in contact with the lower substrate 110 in most regions except the region where the driving chip 130 is disposed. The touch printed circuit board 160 covers an upper surface of the driving chip 130 to be bonded with the touch pad unit 142. In this case, the touch printed circuit board 160 is curved and covers the driving chip 130. The curved shape of the touch printed circuit board 160 is illustrated in FIG. 2.

Referring to FIG. 2, the touch printed circuit board 160 is in contact with the lower substrate 110 on both ends (that is, contact areas C/A) of the region where the driving chip 130 is disposed. The touch printed circuit board is curved in a separate area (SP/A) to cover the driving chip 130. When the touch printed circuit board 160 is curved, an internal space I/A is formed between the touch printed circuit board 160 and the lower substrate 110. A restoring force that acts to restore the curved printed circuit board 160 back to a planar shape affects the lower substrate 110 due to tension. The lower substrate 110 may be deformed by such tension and the deformed lower substrate 110 affects the display element, such as the driving chip 130.

Specifically, in the area (that is, a contact area C/A) where the touch pad unit 142 is disposed, the touch printed circuit board 160 and the lower substrate 110 are in contact with each other. However, in the separate area SP/A, the touch printed circuit board 160 and the lower substrate 110 are separated from each other. The restoring force with respect to the curved touch printed circuit board 160 acts on the lower substrate 110, which is in contact with the touch printed circuit board 160. Therefore, the restoring force is greater if the touch printed circuit board 160 has a greater curvature, and thus a larger tension acts on the lower substrate 110. Further, as illustrated in FIG. 2, when a curvature degree of the touch printed circuit board 160 locally varies, locally different amounts of tension may act on the lower substrate 110. Therefore, the lower substrate 110, which has a lower rigidity than the upper substrate 170, may be locally curved. For convenience in explanation, the lower substrate 110 is shown to have an exaggerated curvature in FIG. 2.

The curved lower substrate 110 may affect the display element. For example, alignment of the liquid crystal disposed on the lower substrate 110 may be affected and light leakage may occur due to such misalignment of the liquid crystal. That is, the tension caused by the curved touch printed circuit board 160 acts on the lower substrate 110, which is in contact with the touch printed circuit board 160. Further, the lower substrate 110 is locally and minutely deformed by such tension, as illustrated in FIG. 2. When the lower substrate 110 is locally deformed, the alignment of the liquid crystal disposed in the display area of the lower substrate 110 may be affected. In this case, light leakage may occur due to the misaligned liquid crystal. Such light leakage causes irregular brightness across the touch screen integrated display device 100.

Further, in the touch screen integrated display device 100 illustrated in FIGS. 1 and 2, in order to reduce the thickness of the bezel, the touch printed circuit board 160 and the display printed circuit board 150, which are connected to the lower substrate 110, are folded onto a rear surface of the lower substrate to allow connection to a system module or other types of components.

In this case, the touch printed circuit board 160 or the display printed circuit board 150, which is folded onto the rear surface of the lower substrate 110, may continuously cause tension not only to the lower substrate 110 but also to the upper substrate 170 due to the curvature restoring force. Therefore, the lower substrate 110 and the upper substrate 170 may be minutely curved.

Also, the touch screen integrated display device 100 is prone to damage due to impacts applied on the device, such as when the device is dropped by accident. Such impacts can cause cracks or other types of deformities at the lower substrate 110 or the upper substrate 170.

### SUMMARY

The lower substrate and the upper substrate are minutely curved, wrinkled, or otherwise deformed by tension, which acts on the lower substrate, caused by a curved or bent touch printed circuit board or display printed circuit board. Such tension may lead to misalignment of the liquid crystal, which causes light leakage. In order to alleviate these deficiencies, a touch screen integrated display device includes a buffering member (or other similar component) that disperses the tension forces caused by the curvature of the touch printed circuit board or the display printed circuit board, which can affect the upper substrate.

According to one aspect of the present disclosure, a touch screen integrated display device reduces the degree of curvature of a lower substrate by using a buffering member (or some other type of structured member) that uniformly disperses the tension forces that act on the lower substrate by the curved touch printed circuit board in order to reduce light leakage and address other problems.

Aspects of the present disclosure are not limited to the above-mentioned aspects, and other aspects, which are not mentioned above, can be clearly understood by those skilled in the art from the following description.

In order to solve the above-described problems, according to an aspect of the disclosure, a touch screen integrated display device includes a driving chip, a flexible printed circuit board, and a buffering member (or some equivalent component). The driving chip is disposed in a non-display area of a lower substrate. The flexible printed circuit board is connected to the lower substrate and covers at least a part of the driving chip. The buffering member (or a similar element) disperses the forces which act on the lower substrate due to the curvature of the flexible printed circuit board. The touch screen integrated display device according to an embodiment of the present disclosure includes a buffering member (or the like), which disperses the force that is applied to the lower substrate by the curved flexible printed circuit board. Therefore, a tension that acts on the lower substrate by the curved flexible printed circuit board may be dispersed and thus deformations on the lower substrate may be reduced, suppressed, or prevented. Accordingly, light leakage caused by such deformations of the lower substrate may be reduced and non-uniform brightness of the touch screen integrated display device may be reduced.

In order to solve the above-described problems, according to an aspect of the present disclosure, a touch screen integrated display device includes a lower substrate, a flexible printed circuit board, and a filling member (or some equivalent thereof). The lower substrate includes a contact area and a separate area. The flexible printed circuit board is in contact with the lower substrate in the contact area and is curved in the separate area to be separated from the lower substrate. The filling member (or some other type of element with such function) is disposed to be in contact with the flexible printed circuit board in the separate area and reduces the space between the flexible printed circuit board and the lower substrate.

In order to solve the above-described problems, according to an aspect of the present disclosure, a touch screen integrated display device includes a substrate including a display area and a non-display area, a driving chip disposed in the non-display area, a flexible substrate, and a buffering layer (or a similar structure). The flexible substrate is connected to at least one electrode connecting unit, which is disposed in the non-display area of the substrate, and covers at least a part of the driving chip. The buffering layer is disposed on the flexible substrate to disperse forces applied to the substrate by the curved flexible substrate. Further, at least a part of the flexible substrate is defined as a buffering layer disposing function area, in which the buffering layer can be positioned. The buffering layer may be made of a resin and the buffering layer disposing function area may be transparent or partially open to allow or improve curing of the buffering layer.

As described above, the flexible substrate including the buffering layer disposing function area in which the buffering layer is positioned, to reduce bending of a substrate by the curved flexible substrate. Further, undesired light leakage may also be reduced.

Other detailed matters of the embodiments are included in the detailed description and the drawings.

According to the present disclosure, the tension which acts on the lower substrate while the touch printed circuit board is curved or bent can be dispersed through a buffering member and thus deformation of the lower substrate is reduced, thereby reducing a light leakage phenomenon.

According to the present disclosure, the deformation of the lower substrate is reduced in order to reduce the resultant deformation of the display element. Further, brightness irregularity across the touch screen integrated display device is also reduced.

The effects according to the present disclosure are not limited to those exemplified above, and additional effects are explained in the present specification.

The effects of the present disclosure are not limited to the aforementioned effects, and other effects, which are not mentioned above, will be apparent to a person having ordinary skill in the art from the following description.

The objects to be achieved by the present disclosure, the means for achieving such objects, and effects of the present disclosure described above do not specify essential features of the claims, and, thus, the scope of the claims is not limited to the embodiments of the present disclosure.

### BRIEF DESCRIPTION OF THE DRAWINGS

The above and other aspects, features and advantages of the present disclosure will be more clearly understood from the following detailed description taken in conjunction with the accompanying drawings, in which:

FIG. 1 is a schematic perspective view illustrating a touch screen integrated display device of the related art;

FIG. 2 is a schematic cross-sectional view taken along II-II′ of FIG. 1 illustrating light leakage phenomenon generated in a touch screen integrated display device of the related art;

FIG. 3 is a schematic plane view illustrating a touch screen integrated display device according to an embodiment of the present disclosure;

FIG. 4 is a schematic cross-sectional view taken along IV-IV′ of FIG. 3 illustrating a touch screen integrated display device according to an embodiment of the present disclosure;

FIG. 5 is a schematic plane view illustrating a pressurizing member for explaining a touch screen integrated display device according to an embodiment of the present disclosure;

FIG. 6 is a schematic cross-sectional view taken along VI-VI′ of FIG. 5 illustrating a touch screen integrated display device according to an embodiment of the present disclosure;

FIG. 7A is a schematic perspective view illustrating a touch screen integrated display device according to an embodiment of the present disclosure;

FIG. 7B is a schematic cross-sectional view taken along VII-VII′ of FIG. 7A illustrating a touch screen integrated display device according to an embodiment of the present disclosure; and

FIGS. 8A and 8B are schematic plane views illustrating a touch screen integrated display device according to an embodiment of the present disclosure.

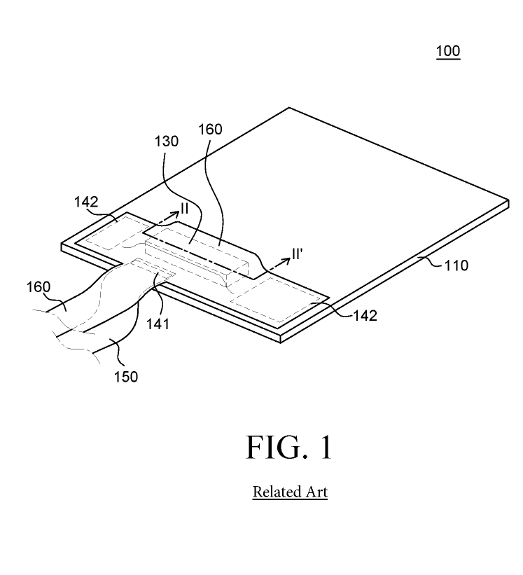

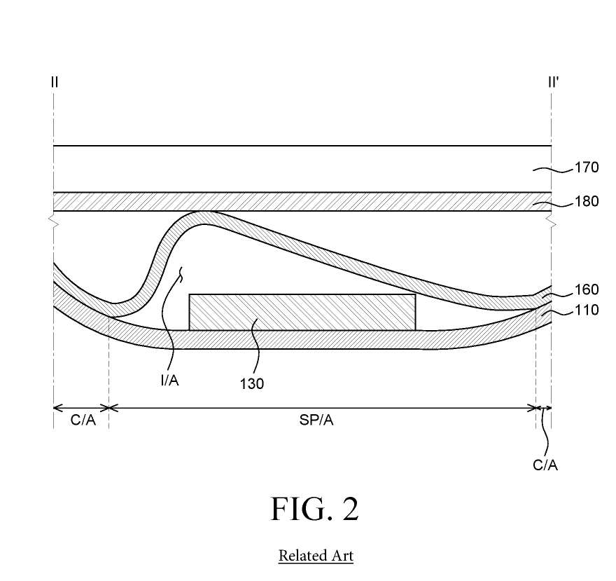

### DETAILED DESCRIPTION OF THE EMBODIMENTS

Advantages and features of the present disclosure, and methods for accomplishing the same will be more clearly understood from embodiments described below with reference to the accompanying drawings. However, the present disclosure is not limited to the following embodiments but may be implemented in various different forms. The embodiments are provided only to complete disclosure of the present disclosure and to fully provide a person having ordinary skill in the art to which the present disclosure pertains with the category of the disclosure, and the present disclosure will be defined by the appended claims.

The shapes, sizes, ratios, angles, numbers, and the like illustrated in the accompanying drawings for describing the embodiments of the present disclosure are merely examples, and the present disclosure is not limited thereto. Like reference numerals generally denote like elements throughout the present specification. Further, in the following description, a detailed explanation of known related technologies may be omitted to avoid unnecessarily obscuring the subject matter of the present disclosure. Terms such as “including,” “having,” and “comprising of” used herein are generally intended to allow other components to be added unless the terms are used with the term “only.” Any references to singular may include plural unless expressly stated otherwise.

Components are interpreted to include an ordinary error range even if not expressly stated.

When the position relation between two parts is described using the terms such as “on,” “above,” “below,” and “next,” one or more parts may be positioned between the two parts unless the terms are used with the term “immediately” or “directly.”

When an element or layer is disposed “on” another element or layer, it means that another layer or another element may be disposed directly on the other element or a third part may be interposed therebetween.

Although the terms “first,” “second,” and the like are used for describing various components, these components are not confined by these terms. These terms are merely used for distinguishing one component from the other components. Therefore, a first component to be mentioned below may be a second component in a technical concept of the present disclosure.

Like reference numerals indicate like elements throughout the specification.

A size and a thickness of each component illustrated in the drawing are illustrated for convenience of description, and the present disclosure is not limited to the size and the thickness of the component illustrated.

The features of various embodiments of the present disclosure can be partially or entirely bonded to or combined with each other and can be interlocked and operated in technically various ways, and the embodiments can be carried out independently of or in association with each other.

Hereinafter, various embodiments of the present disclosure will be described in detail with reference to accompanying drawings.

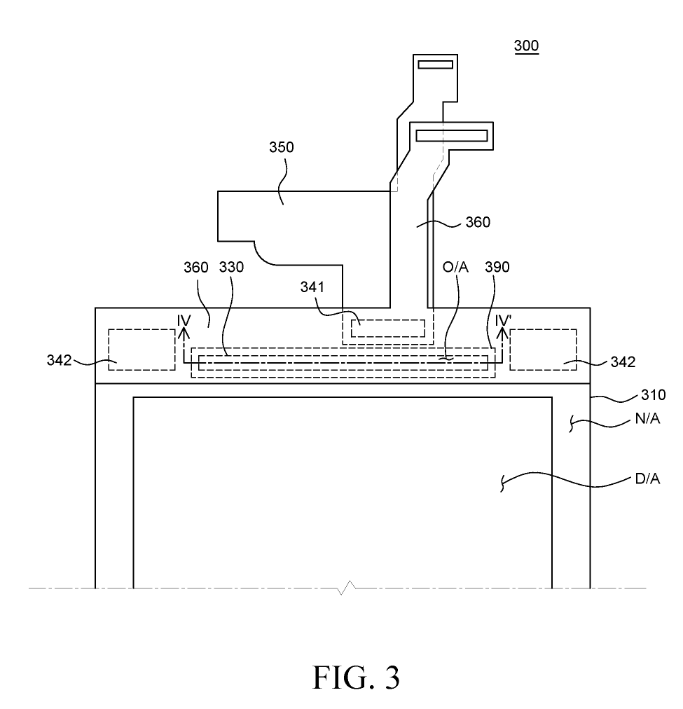

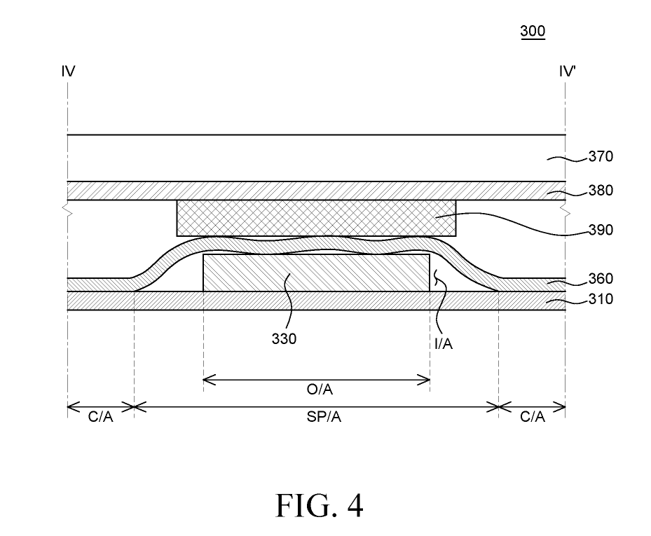

FIG. 3 is a schematic plane view illustrating a touch screen integrated display device 300 according to an embodiment of the present disclosure. FIG. 4 is a schematic cross-sectional view taken along IV-IV′ of FIG. 3 illustrating the touch screen integrated display device 300. Referring to FIGS. 3 and 4, a touch screen integrated display device 300 includes a lower substrate 310, a driving chip 330, a display printed circuit board 350, a touch printed circuit board 360, a buffering member 390, an upper substrate 370, and a black matrix 380. For convenience in explanation, in FIGS. 3 and 4, a display element and a touch electrode which are part of a touch screen are not illustrated and each component is illustrated in a simplified manner.

The lower substrate 310 is a substrate that supports various components of the touch screen integrated display device 300 and may be a glass substrate or a plastic substrate. The substrate 310 provides a display area D/A and a non-display area N/A. The display area D/A refers to an area where an image is displayed and the non-display area N/A refers to an area excluding the display area D/A.

The display elements may be disposed in the display area D/A. The display element may include various elements included in a pixel of the touch screen integrated display device 300. For example, when the touch screen integrated display device 300 is a liquid crystal display device, the display element may include a thin film transistor (TFT), a pixel electrode which is connected to the thin film transistor, a common electrode which is separated from the pixel electrode, and a liquid crystal layer disposed on the pixel electrode. Further, when the touch screen integrated display device 300 is an organic light emitting display device, the display element may include a thin film transistor, an anode which is connected to the thin film transistor, a cathode which is separated from the anode, and at least one organic layer which is disposed between the anode and the cathode. Since the display elements including the thin film transistor are disposed on the lower substrate 310, the lower substrate 310 may be referred to as a TFT substrate.

A touch electrode which senses a touch input of the user may be disposed in the display area D/A. The touch electrode may include a sensing electrode and a driving electrode which intersect with each other. The sensing electrode and the driving electrode have different electrical potentials. When an object having static electricity, such as a finger of the user or a stylus, approaches the touch electrode, a potential difference between the sensing electrode and the driving electrode changes. The touch input of the user may be sensed based on a touch signal generated due to the change of the potential difference. The touch electrode and the display element are disposed to be adjacent to each other. For example, when the touch screen integrated display device 300 is a liquid crystal display device, the touch electrode is disposed on the same plane as the common electrode of the display element. At least a part of the touch electrode may function as a common electrode. Further, when the touch screen integrated display device 300 is an organic light emitting display device, the touch electrode is disposed below the upper substrate which is opposite to the lower substrate 310.

In the non-display area N/A, various elements other than the touch electrode and the display element are disposed. As illustrated in FIG. 3, a driving chip 330 is disposed in the non-display area N/A. The driving chip 330 may be mounted on the lower substrate 310 as a chip on glass (COG) type. Even though one driving chip is illustrated in FIG. 3, two or more driving chips 330 may be included. The driving chip 330 is connected to the display element to supply a predetermined signal to the display element. For example, the driving chip 330 may be a data driving chip which supplies a data signal to the display element. When the touch screen integrated display device 300 is a liquid crystal display device, at least a part of the touch electrode functions as a common electrode. The data driving chip 330 may be configured to apply a common voltage to the common electrode during a display period when the display element operates and apply a touch driving voltage to the touch electrode during a touch sensing period when the touch screen operates. Further, the driving chip 330 may be a gate driving chip which supplies a gate signal to the display element. When the driving chip 330 is a gate driving chip, the display element is supplied with a gate signal through a gate line which is connected to the driving chip 330.

In the non-display area N/A of the lower substrate 310, a display pad unit 341 and a touch pad unit 342 are disposed. The display pad unit 341 is connected to the driving chip 330 and transmits various signals including a control signal to the driving chip 330. The touch pad unit 342 is connected to the touch electrode and receives a touch signal generated in the touch electrode. In the touch screen integrated display device 300, both the driving chip 330 and the touch electrode are disposed on the lower substrate 310. Therefore, both the display pad unit 341 and the touch pad unit 342 are disposed on the same plane of the lower substrate 310.

The display printed circuit board 350 is connected to the display pad unit 341 in the non-display area N/A and is connected to the driving chip 330 by the display pad unit 341. Further, the display printed circuit board 350 is connected to a separate printed circuit board PCB on which a timing control unit and a power supply are disposed. The display printed circuit board 350 transmits signals between the driving chip 330 and the printed circuit board.

The touch printed circuit board 360 is connected to the touch pad unit 342 in the non-display area N/A and is electrically connected to the touch electrode through the touch pad unit 342. Further, the touch printed circuit board 360 is connected to the touch sensing unit. The touch printed circuit board 360 transmits a touch signal generated from the touch electrode to the touch sensing unit and the touch sensing unit senses a touch input of the user based on the touch signal.

The touch printed circuit board 360 and the display printed circuit board 350 can be flexible printed circuit boards (FPCBs). Therefore, the touch printed circuit board 360 and the display printed circuit board 350 may be curved or bent due to their flexibility.

The touch printed circuit board 360 at least partially covers the driving chip 330. As described above, in an in-cell type touch screen, the touch electrode and the display element are disposed adjacent to each other. Therefore, both the touch pad unit 342, which is connected to the touch electrode and the display pad unit 341, which is connected to the display element are disposed on the same plane of the lower substrate 310. The touch pad unit 342 includes a plurality of pads, each of which is connected to the touch electrode in a one-to-one manner. The plurality of pads is densely disposed in a small space to reduce a thickness of a bezel of the touch screen integrated display device 300. For example, as illustrated in FIG. 3, the plurality of pads which configures the touch pad unit 342 is disposed at outer parts of both ends of a region where the driving chip 330 is disposed and mostly occupies a region other than a region where the driving chip 330 is disposed. The touch printed circuit board 360 is bonded with the touch pad unit 342 and is in contact with the lower substrate 310 through the touch pad unit 342. As described above, the touch pad unit 342 is disposed at the outer parts of both ends of a region where the driving chip 330 is disposed. Therefore, the touch printed circuit board 360 covers the upper surface of the driving chip 330 to be bonded with the touch pad unit 342.

Referring to FIG. 4, the touch printed circuit board 360 has a particular configuration to cover the upper surface of the driving chip 330. For example, the touch printed circuit board 360 is in contact with the lower substrate 310 in the contact area C/A and is separated from the lower substrate 310 in the separate area SP/A, and overlaps the upper surface of the driving chip 330 in the overlap area O/A. Therefore, in the separate area SP/A, an internal space I/A is formed by the curved touch printed circuit board 360 between the touch printed circuit board 360 and the lower substrate 310.

The upper substrate 370, which is opposite to the lower substrate 310, is disposed on the touch printed circuit board 360. The upper substrate 370 protects components of the touch screen integrated display device 300 disposed on the lower substrate 310 from the external environment. The upper substrate 370 may be formed of a material such as glass having a strong rigidity to protect the components of the touch screen integrated display device 300 from external impacts, foreign debris, or moisture. Further, the upper substrate 370 may also be formed of a material such as plastic which can be thermally formed and has good machinability. Specifically, when the upper substrate 310 is formed of glass having high rigidity, the upper substrate 310 may be referred to as a cover glass.

A black matrix 380 is disposed below the upper substrate 370. The black matrix 380 is disposed to correspond to the non-display area N/A so that light from the display element is not leaked to the non-display area N/A. Therefore, as illustrated in FIG. 4, the black matrix 380 is disposed to overlap the driving chip 330 and the touch printed circuit board 360.

The buffering member 390 (or similar element) can be disposed below the black matrix 380. The buffering member 390 is in contact with at least a part of the touch printed circuit board 360. The buffering member 390 is in contact with at least a part of the touch printed circuit board 360 between the upper substrate 370 and the lower substrate 310. Therefore, the buffering member 390 may be referred to as an intermediate member.

The buffering member 390 may be in at least partial contact with the touch printed circuit board 360 in the separate area SP/A where the touch printed circuit board 360 is curved, to press against the touch printed circuit board 360. In this specification, “press against” means to apply pressure to an object using force applied from the outside and/or to apply pressure to an object to reduce movement or deformation.

The buffering member 390 presses against the touch printed circuit board 360 to relieve a tension generated by the curved touch printed circuit board 360. Namely, the buffering member 390 at least partially presses against the touch printed circuit board 360 and thus the buffering member 390 may be referred to as a pressing member.

The buffering member 390 is disposed to at least partially correspond to the separate area SP/A. For example, as illustrated in FIG. 4, the buffering member 390 is disposed to entirely cover the upper surface of the driving chip 330.

The buffering member 390 may have a particular thickness that allows the buffering member 390 to be in contact with the touch printed circuit board 360. The particular thickness may be based on a distance between the upper substrate 370 and the lower substrate 310; a thickness of the driving chip 330; a length, an area, and a thickness of the touch printed circuit board 360; and a curvature degree of the touch printed circuit board 360. For example, when a distance between a lower surface of the black matrix 380 and an upper surface of the lower substrate 310 is 900 μm and a sum of the thickness of the driving chip 330 and the thickness of the touch printed circuit board 360 is 835 μm, a thickness of the buffering member 390 may be approximately 65 μm. Therefore, a space between the touch printed circuit board 360 and the black matrix 380 is fully filled with the buffering member 390. In this case, the space between the touch printed circuit board 360 and the black matrix 380 may be filled with the buffering member 390, and thus the buffering member 390 may be referred to as a filling member. However, the thickness of the filling member 390 is not limited thereto and may be less than 65 μm. In this case, there may be a minute space between the touch printed circuit board 360 and the driving chip 330. However, the buffering member 390 may be in at least partial contact with the upper surface of the touch printed circuit board 360 and presses against the touch printed circuit board 360. More specifically, when the thickness of the buffering member 390 is smaller than 65 μm, the space between the black matrix 380 and the touch printed circuit board 360 buffering member 390 is not completely filled with the buffering member 390. However, the touch printed circuit board 360 is curved to be positioned higher than the upper surface of the driving chip 330, and the lower surface of the buffering member 390 may be in contact with a portion of the touch printed circuit board 360. That is, the buffering member 390 does not need to completely fill the space between the black matrix 380 and the touch printed circuit board 360. When the lower surface of the buffering member 390 is in contact with the upper surface of the touch printed circuit board 360 so that the buffering member 390 presses against the touch printed circuit board 360, the thickness of the buffering member 390 may be smaller than 65 μm. As a result, the buffering member 390 may be formed to have various thicknesses, which allows the buffering member 390 to be in partial contact with the touch printed circuit board 360. The curvature degree of the touch printed circuit board 360 is determined by the length, the area, and the thickness of the touch printed circuit board 360. Further, the distance between the black matrix 380 and the curved portion of the touch printed circuit board 360 may be determined by the curvature degree of the touch printed circuit board 360. The buffering member 390 has a thickness which allows the buffering member 390 to be in at least partial contact with the upper surface of the touch printed circuit board 360 below the black matrix 380. The buffering member 390 has a thickness that occupies approximately 60% to 100% of the distance between the lower surface of the black matrix 380 and the upper surface of the touch printed circuit board 360.

The buffering member 390 can be made of various materials which may at least partially press against the touch printed circuit board 360 and thus the material of the buffering member 390 is not specifically limited. Also, the buffering member 390 may be formed by various processes. For example, the buffering member 390 may have a film shape and be attached below the black matrix 380. Alternatively, a resin may be applied below the black matrix 380 and then hardened so that the buffering member 390 may be formed below the black matrix 380. On the other hand, a film shaped resin may be attached below the black matrix 380 to form the buffering member 390.

The buffering member 390 presses against the touch printed circuit board 360 to disperse or reduce a tension which acts on the lower substrate 310 due to the curvature of the touch printed circuit board 360. As described above, the touch printed circuit board 360 partially covers the upper surface of the driving chip 330 and the touch printed circuit board 360 is curved in the separate area SP/A to cover the upper surface of the driving chip 330. When the touch printed circuit board 360 is curved, the tension acts on the lower substrate 310 which is in contact with the touch printed circuit board 360. That is, the touch printed circuit board 360 is bonded with the lower substrate 310 in the contact area C/A, so that the restoring force with respect to the curved touch printed circuit board 360 may act on the lower substrate 310. Further, when the touch printed circuit board 360 is additionally bent outside of the lower substrate 310 to be connected to the touch sensing unit, the restoring force with respect to the bent touch printed circuit board 360 may also be applied to the lower substrate 310 as a tension through the contact area C/A.

If the buffering member 390 is not employed, the tension by the curved touch printed circuit board 360 may detrimentally act on the lower substrate 310 which is in contact with the touch printed circuit board 360 through the touch pad unit 342. When such tension acts on the lower substrate 310, deformations may be formed on the lower substrate 310. The deformations (e.g., minute curvatures) of the lower substrate 310 may cause problems to the display element in the display area. The deformed display element may cause light leakage or irregular brightness of the touch screen integrated display device 300. For example, when the display element includes liquid crystal, the deformations of the lower substrate 310 may cause misalignment of the liquid crystal. Therefore, even though a specific pixel is turned off, light may leak through the liquid crystal misalignment. Further, when the display element includes an organic light emitting element, an alignment or a level of the organic light emitting element may be minutely deformed by the deformations of the lower substrate 310. Further, a travel path of the light emitted from the organic light emitting element is minutely changed to thus alter the brightness of a specific pixel.

Small deformations of the lower substrate 310 may be significantly generated in an outer region (that is, a region excluding the overlap area O/A from the separate area SP/A) of a region where the driving chip 330 is disposed. As the driving chip 330 is bonded with the lower substrate 310 in the overlap area O/A, due to the curved touch printed circuit board 360, the tension in the overlap area O/A is dispersed to the driving chip 330 and the lower substrate 310, respectively. As a result, the deformation of the lower substrate 310 in the overlap area O/A is relatively small. In contrast, in the outer region of the region where the driving chip 330 is disposed, the driving chip 330 is not disposed on the lower substrate 310. Therefore, the tension in the outer region acts only on the lower substrate 310 and the lower substrate 310 in the outer region may be relatively significantly deformed. In this case, the display element may be deformed similarly to the misalignment of the liquid crystal by the minute deformation of the lower substrate 310. Specifically, a display element that is disposed in a region adjacent to a region where the lower substrate 310 is locally and significantly deformed may be frequently deformed. For example, the lower substrate 310 is locally and significantly deformed at both ends of the driving chip 330, the liquid crystal may be undesirably twisted at a corner of the display area which is the closest to both ends of the driving chip 330 and thus light leakage may occur in the display area. Therefore, the brightness uniformity of the touch screen integrated display device 300 may be lowered.

In contrast, when the buffering member 390 is provided, the tension due to the curved touch printed circuit board 360 is dispersed or reduced. That is, the buffering member 390 is in at least partial contact with the upper surface of the touch printed circuit board 360. In the portion where the buffering member 390 is in contact with the touch printed circuit board 360, a predetermined force is generated in an opposite direction to the tension caused by the curved touch printed circuit board 360 in accordance with the principle of action and reaction to relieve or disperse the tension. In this case, the larger an area where the buffering member 390 is in contact with the touch printed circuit board 360, the more the tension is dispersed. The buffering member 390 is disposed below the black matrix 380 which is in contact with the upper substrate 370. The upper substrate 370 is harder (i.e. more rigid) than the lower substrate 310. Therefore, even though the tension is generated by the curved touch printed circuit board 360, the buffering member 390, which is in contact with the touch printed circuit board 360 and the upper substrate 370, is firmly supported by the buffering member 390 to thus disperse or relieve the tension of the touch printed circuit board 360.

As a result, as illustrated in FIG. 4, when the buffering member 390 and the touch printed circuit board 360 are in contact with each other, the tension caused by the curved touch printed circuit board 360 is relieved, which may reduce the deformation of the lower substrate 310. In this case, the internal space I/A formed by the curved touch printed circuit board 360 may be reduced as compared with the case when the buffering member 390 is not provided. That is, the touch printed circuit board 360 is less likely to become loose or dislodged due to the buffering member 390 applying pressure thereto, and the touch printed circuit board 360 may be closely attached to the driving chip 330. According to some embodiments, a space between the upper surface of the touch printed circuit board 360 and the lower portion of the black matrix 380 is substantially or fully filled with the buffering member 390. Therefore, the touch printed circuit board 360 is completely attached to the driving chip 330. When the touch printed circuit board 360 is completely attached to the driving chip 330, the internal space I/A formed between the touch printed circuit board 360 and the lower substrate 310 due to the curved touch printed circuit board 360 may be reduced. Further, the buffering member 390 is completely attached to the upper surface of the touch printed circuit board 360, so that the tension caused by the curved touch printed circuit board 360 may be more efficiently dispersed. Therefore, the lower substrate 310 is maintained to be substantially flat, the deformation of the display element is reduced, and the light leakage is reduced or prevented.

As described above, the touch screen integrated display device 300 according to an embodiment of the present disclosure includes the buffering member 390 which at least partially presses the touch printed circuit board 360. Therefore, the light leakage caused by the curved touch printed circuit board 360 may be significantly reduced. That is, the buffering member 390 uniformly disperses the tension that acts on the lower substrate by the curved touch printed circuit board 360, thereby reducing the deformation of the lower substrate 310. As a result, the deformation of the display element may be reduced. Further, a film type or a resin type buffering member 390 may be attached or formed below the upper substrate 370, so that the light leakage may be reduced without using a complex process.

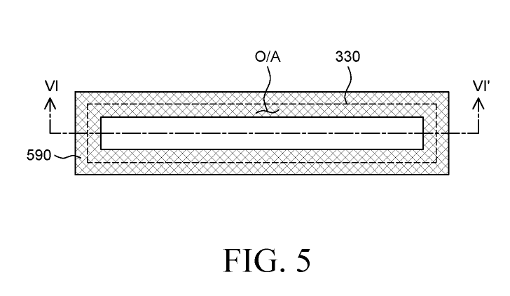

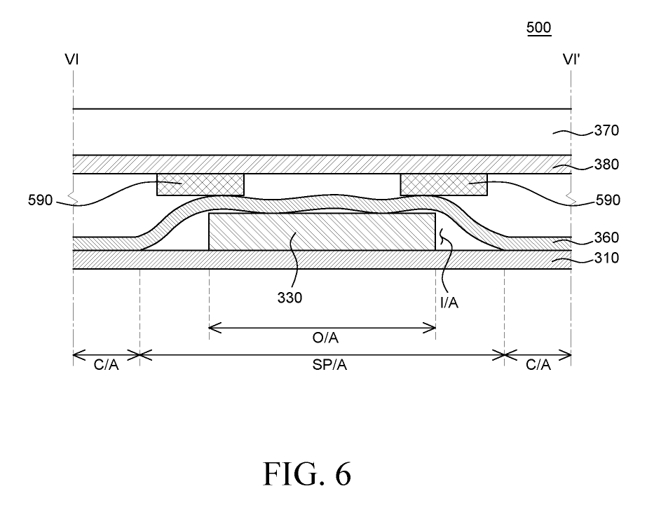

FIG. 5 is a schematic plane view illustrating a buffering member for explaining a touch screen integrated display device 500 according to an embodiment of the present disclosure. FIG. 6 is a schematic cross-sectional view taken along VI-VI′ of FIG. 5 illustrating the touch screen integrated display device 500. Except a shape of a buffering member 590, the touch screen integrated display device 500 of FIGS. 5 and 6 may be substantially the same as the touch screen integrated display device 300 of FIGS. 3 and 4, and thus redundant description will be omitted. For convenience in explanation, components excluding the buffering member 590 and a driving chip 330 are omitted in FIG. 5.

Referring to FIG. 5, the buffering member 590 is disposed to correspond to a border or boundary of the overlap area O/A where the driving chip 330 is bonded with the lower substrate 310. That is, the buffering member 590 does not entirely cover an upper surface of the driving chip 330 and overlaps an edge of the driving chip 330.

Referring to FIG. 6, the buffering member 590 is disposed to correspond to the edge of the overlap area O/A and is in at least partially contact with the touch printed circuit board 360 in the separate area SP/A. The touch printed circuit board 360 may be significantly curved at the edge of the driving chip 330. Specifically, the touch printed circuit board 360 starts to curve at or near the border between the contact area C/A and the separate area SP/A and the curved direction is changed at the edge (that is, the border of the overlap area O/A) of the driving chip 390. The touch printed circuit board 360 covers the upper surface of the driving chip 330 in the overlap area O/A. When the touch printed circuit board 360 is not smoothly curved, but irregularly curved, the radii of curvature of certain curved portions of the printed circuit board 360 may vary. Specifically, as described above, the touch printed circuit board 360 may be bent to be in contact with a separate printed circuit board. Therefore, the curved shape of the touch printed circuit board 360 may be deformed due to such bending. For example, due to bending of the touch printed circuit board 360, the touch printed circuit board 360 may have a concave curve at a center of the upper surface of the driving chip 330. In this case, the touch printed circuit board 360 may have a convex curve at the edge of the driving chip 330. The convex curve may have a smaller radius of curvature than that of the other curve of the touch printed circuit board 360. The smaller the radius of curvature of the touch printed circuit board 360 is, the stronger the restoring force with respect to the curve is. The restoring force acts on the lower substrate 310 as a tension force. As a result, the tension caused by the curved touch printed circuit board 360 is generated mainly at the edge of the driving chip 330. As described above, the tension caused by the curved touch printed circuit board acts on the lower substrate 310 and the lower substrate 310 may be locally deformed by the tension. However, the buffering member 590 is in contact with the touch printed circuit board 390 at the edge of the driving chip 330 where the touch printed circuit board 390 is significantly curved. Therefore, the tension of the touch printed circuit board 360 generated at the edge is reduced. Thus, deformation of the lower substrate 310 may be reduced or even prevented.

A touch screen integrated display device 500 according to an embodiment of the present disclosure includes the buffering member 590 to disperse the tension caused by the curved touch printed circuit board 390. Therefore, the tension caused by the touch printed circuit board 390 may be uniformly dispersed and the deformation of the lower substrate 310 may be reduced. Therefore, the deformation (for example, deformation of the liquid crystal alignment) of the display element may be reduced and the light leakage caused by the deformation of the display element may be reduced. Specifically, the buffering member 590 is formed only at the border of the overlap area O/A where a stress is easily concentrated so that a material for forming the buffering member 590 may be saved.

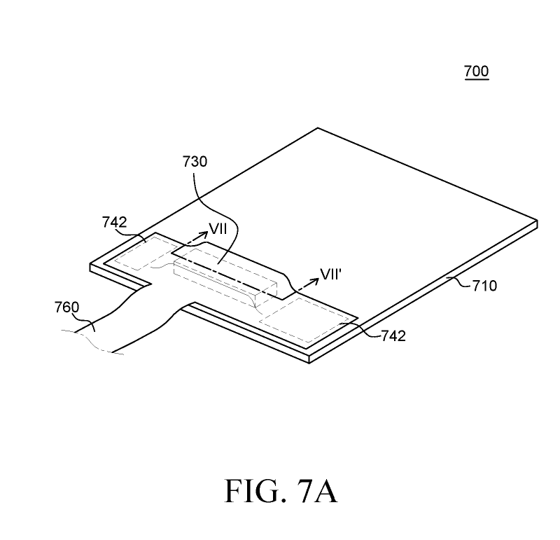

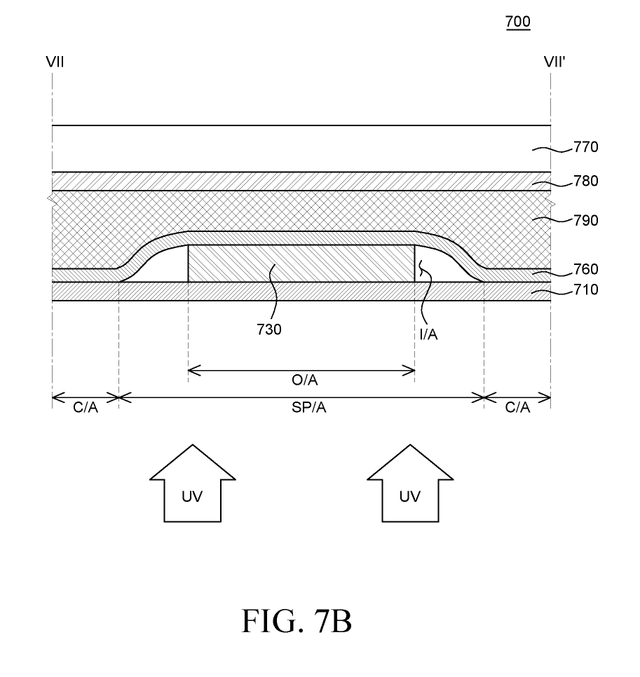

FIG. 7A is a schematic perspective view illustrating a touch screen integrated display device 700 according to an embodiment of the present disclosure and FIG. 7B is a schematic cross-sectional view taken along VII-VII′ of FIG. 7A illustrating the touch screen integrated display device 700.

First, referring to FIG. 7A, in a touch screen integrated display device 700, a driving chip 730 is disposed on a lower substrate 710. At least one electrode connecting unit 742 is provided on the lower substrate 710 to connect the lower substrate 710 with a flexible substrate 760. A part of the flexible substrate 760 covers the driving chip 730 so that there may be a gap therebetween. When the extension of flexible substrate 760 is folded onto a rear surface of the lower substrate 710, the flexible substrate 760 on the driving chip 730 may apply irregular and undesirable pressure to the lower substrate 710.

The flexible substrate 760 may be a flexible printed circuit board and may be an integrated printed circuit board which is connectable to a display related electrode and a touch related electrode of the lower substrate 710.

In some embodiments, the touch printed circuit board is combined with the display printed circuit board to reduce the number of printed circuit boards. A detailed description thereof will be provided below.

Referring to FIG. 7B, the touch screen integrated display device 700 includes an upper substrate 770 that is opposite to the lower substrate 710. A part of the upper substrate 770 includes a black matrix 780 corresponding to a non-display area N/A of the lower substrate 710.

A flexible substrate 760 disposed between the lower substrate 710 and the upper substrate 770 covers a driving chip 730 in an overlap area O/A. The flexible substrate 760 may apply an irregular pressure to the upper substrate 770. Therefore, a buffering layer 790 is disposed between the flexible substrate 760 and the upper substrate 770 to cause any pressure applied to the upper substrate 770 to be more uniform.

The buffering layer 790 which is disposed on the flexible substrate 760 may be formed of a resin composition. For example, the buffering layer 790 may be formed of a photo curable resin composition which is cured by ultraviolet rays or infrared rays. However, a material of the buffering layer 790 is not limited thereto and the buffering layer 790 may be formed of a resin composition which is thermally cured or naturally cured. When the buffering layer 790 is formed of an UV curable resin composition which is cured by the ultraviolet ray, the UV curable resin composition may include acrylate monomer, acrylate oligomer, a photo initiator, and additives. The photo initiator initiates polymerization of acrylate monomer and acrylate oligomer based on ultraviolet rays. The additives are materials which increase adhesiveness of the UV curable resin composition and a silane compound may be used therefor. The buffering layer 790 may be configured by a polymer which is formed by curing the resin composition.

When the buffering layer 790 disposed on the flexible substrate 760 is configured by the photo curable resin composition, as illustrated in FIG. 7B, a light path is formed to irradiate UV rays from a lower side of the lower substrate 710 to cure the buffering layer 790. A technical configuration which can be used to dispose the buffering layer 790 will be described below.

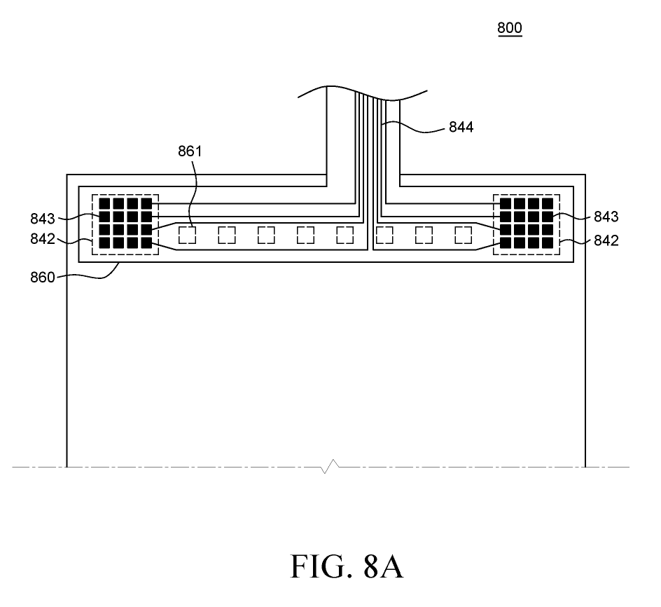

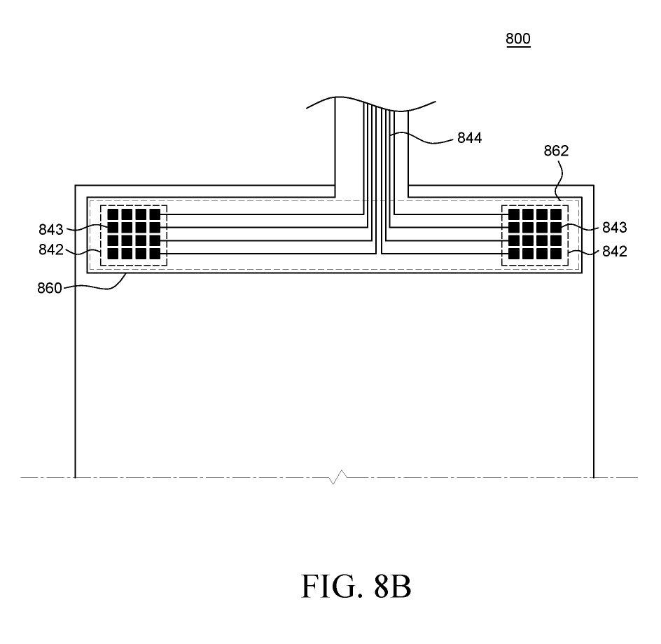

FIGS. 8A and 8B are schematic plane views illustrating a touch screen integrated display device 800 according to an embodiment of the present disclosure.

Referring to FIG. 8A, in a touch screen integrated display device 800, an electrode connecting unit 842 is disposed on a lower substrate 810 and is connected to a flexible substrate 860 on which a wiring electrode 844 is disposed. A connection electrode 843 is disposed on the electrode connecting unit 842.

The flexible substrate 860 is electrically connected to the lower substrate (e.g., 710 as shown in FIGS. 7A and 7B) through the electrode connecting unit 842 to be electrically connected to a touch related signal and display element related electrodes.

A buffering layer disposing function area 861 is provided on the flexible substrate 860 to accommodate the buffering layer 790 as shown in FIGS. 7A and 7B. The buffering layer disposing function area 861 is an area where ultraviolet rays pass through an upper portion of the flexible substrate 860 from the lower side of the lower substrate 810. In this case, the ultraviolet rays cure the buffering layer 790 which is formed of the photo curable material as described above.

The buffering layer disposing function area 861 which passes the ultraviolet rays through the upper portion of the flexible substrate 860 may be formed of a transparent material or may be partially open with respect to the flexible substrate 860.

Even though the description is provided with reference to FIG. 8B, components which are the same or substantially the same as the components of FIG. 8A will not be redundantly described.

Referring to FIG. 8B, the flexible substrate 860 may be a printed circuit board which is substantially formed of a transparent material. When the flexible substrate 860 is formed of such transparent material, the flexible substrate 860 itself may be defined as the buffering layer disposing function area 861 as it is.

Further, the wiring electrode 844 disposed on the flexible substrate 860 may be formed of a transparent electrode to increase transmittance of light such as ultraviolet rays. A transparent electrode may be used for a material of the wiring electrode 844. However, even when a wiring electrode 844 formed of a metal material is used, a substantial difference of curing rates of the buffering layer 790 may not be significant due to diffraction which may occur when light passes between electrodes. As such, various types of materials can be employed based upon such considerations.

The embodiments of the present disclosure can also be described as follows:

According to an aspect of the present disclosure, a touch screen integrated display device comprises a driving chip in a non-display area of a lower substrate, a flexible printed circuit board connected to the lower substrate and covering at least a part of the driving chip, and a buffering member covering the flexible printed circuit board and configured to reduce damage to the flexible printed circuit board.

According to another aspect of the present disclosure, the buffering member may be in contact with an upper surface of the flexible printed circuit board and the buffering member overlaps at least an edge of the driving chip.

According to still another aspect of the present disclosure, the touch screen integrated display device may further comprise an upper substrate which is opposite to the lower substrate and having a greater hardness than the lower substrate. The buffering member may be fixed onto a lower surface of the upper substrate to disperse forces applied to the lower substrate caused by the curvature of the flexible printed circuit board.

According to still another aspect of the present disclosure, the buffering member may be a film or a resin.

According to still another aspect of the present disclosure, the touch screen integrated display device may further comprise a display element and a touch electrode in a display area of the lower substrate. The flexible printed circuit board may be a touch printed circuit board configured to receive signals from the touch electrode.

The touch screen integrated display device according to an aspect of the present disclosure includes a buffering member which disperses the force which is applied to the lower substrate by the curved flexible printed circuit board. Therefore, a tension which acts on the lower substrate by the curve flexible printed circuit board may be dispersed and thus minute deformation of the lower substrate may be suppressed. Accordingly, light leakage caused by the minute deformation of the lower substrate may be reduced and irregular brightness of the touch screen integrated display device may be reduced.

According to an aspect of the present disclosure, a touch screen integrated display device includes a lower substrate, a flexible printed circuit board, and a filling member. The lower substrate includes a contact area and a separate area. The flexible printed circuit board is in contact with the lower substrate in the contact area and is curved on the separate area so as to be separated from the lower substrate. The filling member is in contact with the flexible printed circuit board in the separate area and reduces a space between the flexible printed circuit board and the lower substrate.

According to another aspect of the present disclosure, the display device may further include a driving chip which is disposed between the flexible printed circuit board and the lower substrate in the separate area and an upper substrate which is opposite to the lower substrate. The filling member may be disposed between the upper substrate and the flexible printed circuit board in the separate area.

According to still another aspect of the present disclosure, the filling member presses against at least a part of the flexible printed circuit board in the separate area to reduce a tension which is applied to the lower substrate by the curved flexible printed circuit board.

According to an aspect of the present disclosure, a display device includes a TFT substrate, a flexible circuit board, a cover glass, and an intermediate member. The TFT substrate includes a plurality of thin film transistors TFTs. The flexible circuit board is electrically connected to the TFT substrate. The cover glass is opposite to the TFT substrate. The intermediate member may be configured to reduce light leakage generated by a flexible circuit board having a curved shape between the cover glass and the TFT substrate.

According to another aspect of the present disclosure, the intermediate member may be a film type resin is partially attached onto an inner surface of the cover glass.

According to still another aspect of the present disclosure, a thickness of the intermediate member may be based on a distance between the TFT substrate and the cover glass, and further based on a length, an area, and a degree of curvature of the flexible circuit board.

According to still another aspect of the present disclosure, the display device may further include a driving chip between the TFT substrate and the flexible circuit board. The intermediate member may be configured to reduce the tension created by the curved flexible circuit board on the driving chip.

According to an aspect of the present disclosure, a touch screen integrated display device includes a lower substrate including a display area and a non-display area, a flexible substrate, and a buffering layer. The flexible substrate is connected to at least one electrode connecting unit disposed in the non-display area. The buffering layer is disposed on the flexible substrate. At least a part of the flexible substrate is a buffering layer disposing function area configured to accommodate the buffering layer on the flexible substrate.

According to another aspect of the present disclosure, the buffering layer disposing function area may transmit ultraviolet (UV) rays.

According to still another aspect of the present disclosure, in the buffering layer disposing function area, the flexible substrate may be transparent or the flexible substrate has an opening.

According to still another aspect of the present disclosure, the touch screen integrated display device may further include a driving chip disposed in the non-display area. The flexible substrate may overlap at least a part of the driving chip.

According to still another aspect of the present disclosure, the buffering layer may be formed of a photo curable resin which is cured by light.

According to still another aspect of the present disclosure, connection electrodes may be disposed both on the flexible substrate and the electrode connecting unit, and the connection electrodes may be electrically connected to each other.

According to still another aspect of the present disclosure, the flexible substrate may include a wiring electrode electrically connected to the connection electrode. The wiring electrode may be transparent or have transparent characteristics.

According to still another aspect of the present disclosure, the touch screen integrated display device may further include an upper substrate which is opposite to the lower substrate. The buffering layer may have a particular thickness sufficient for buffering the upper substrate and the flexible substrate.

As described above, the flexible substrate including the buffering layer disposing function area in which the buffering layer is freely disposed is used, to reduce bending of a substrate by the bent flexible substrate. Further, the light leakage may also be reduced.

Although the embodiments of the present disclosure have been described in detail with reference to the accompanying drawings, the present disclosure is not limited thereto and may be embodied in many different forms without departing from the technical concept of the present disclosure. Therefore, the embodiments of the present disclosure are provided for illustrative purposes only but not intended to limit the technical concept of the present disclosure. The scope of the technical concept of the present disclosure is not limited thereto. Therefore, it should be understood that the above-described embodiments are illustrative in all aspects and do not limit the present disclosure. The protective scope of the present disclosure should be construed based on the following claims, and all the technical concepts in the equivalent scope thereof should be construed as falling within the scope of the present disclosure.

What is claimed is:

1. A touch screen integrated display device, comprising:
a lower substrate including a contact area and a separate area;
a flexible printed circuit board in contact with the lower substrate in the contact area, the flexible printed circuit board curved on the separate area so as to be separated from the lower substrate; and
a filling member in contact with the flexible printed circuit board in the separate area, the filling member reducing empty space between the flexible printed circuit board and the lower substrate.

2. The touch screen integrated display device according to claim 1, further comprising:
a driving chip disposed between the flexible printed circuit board and the lower substrate in the separate area; and
an upper substrate opposite to the lower substrate,
wherein the filling member is disposed between the upper substrate and the flexible printed circuit board in the separate area.

3. The touch screen integrated display device according to claim 1, wherein the filling member presses against at least a part of the flexible printed circuit board in the separate area to reduce a tension applied to the lower substrate by the curved flexible printed circuit board.

4. A touch screen integrated display device, comprising:
a TFT substrate including a plurality of thin film transistors (TFTs);
a flexible circuit board electrically connected to the TFT substrate;
a cover glass opposite to the TFT substrate; and
an intermediate member configured to reduce light leakage generated by the flexible circuit board having a curved shape between the cover glass and the TFT substrate.

5. The touch screen integrated display device according to claim 4, wherein the intermediate member is a film type resin partially attached onto an inner surface of the cover glass.

6. The touch screen integrated display device according to claim 5, wherein a thickness of the intermediate member is based on a distance between the TFT substrate and the cover glass, and is further based on a length, an area, and a degree of curvature of the flexible circuit board.

7. The touch screen integrated display device according to claim 6, further comprising:
a driving chip between the TFT substrate and the flexible circuit board,
wherein the intermediate member is configured to reduce tension created by the curved flexible circuit board on the driving chip.

8. A touch screen integrated display device, comprising:
a lower substrate including a display area and a non-display area;
a flexible substrate connected to at least one electrode connecting unit disposed in the non-display area; and
a buffering layer on the flexible substrate,
wherein at least a part of the flexible substrate is a buffering layer disposing function area configured to accommodate the buffering layer on the flexible substrate.

9. The touch screen integrated display device according to claim 8, wherein the buffering layer disposing function area transmits ultraviolet (UV) rays.

10. The touch screen integrated display device according to claim 9, wherein in the buffering layer disposing function area, the flexible substrate is transparent, the flexible substrate has an opening, or flexible substrate is transparent and has an opening.

11. The touch screen integrated display device according to claim 8, further comprising:
a driving chip disposed in the non-display area,
wherein the flexible substrate overlaps at least a part of the driving chip.

12. The touch screen integrated display device according to claim 8, wherein the buffering layer is formed of a photo curable resin.

13. The touch screen integrated display device according to claim 8, wherein connection electrodes are disposed both on the flexible substrate and the electrode connecting unit, and the connection electrodes are electrically connected to each other.

14. The touch screen integrated display device according to claim 13, wherein the flexible substrate includes wiring electrodes electrically connected to the connection electrodes, wherein the wiring electrodes are transparent.

15. The touch screen integrated display device according to claim 8, further comprising:
an upper substrate opposite to the lower substrate,
wherein the buffering layer has a thickness sufficient for buffering the upper substrate and the flexible substrate.
